(19) United States
(12) Patent Application Publication
(10) Pub. No.: US 2024/0328961 A1
(43) Pub. Date: Oct. 3, 2024

(54) INSPECTION SYSTEM AND METHOD FOR ANALYZING FAULTS

(71) Applicant: WICKON HIGHTECH GMBH, Landau (DE)

(72) Inventor: Roman WIESER, Landau / Isar (DE)

(73) Assignee: WICKON HIGHTECH GMBH, Landau (DE)

(21) Appl. No.: 18/694,001

(22) PCT Filed: Sep. 21, 2022
(86) PCT No.: PCT/EP2022/076260

§ 371 Date: Mar. 21, 2024

(30) Foreign Application Priority Data
Sep. 22, 2021 (DE) 10 2021 124 507.9

(51) Int. Cl. G01N 21/95; G01N 21/31; G06T 7/00; G06T 7/521; G06T 7/60; G06T 7/90

(52) U.S. Cl. CPC G01N 21/9501; G01N 21/31; G06T 7/001; G06T 7/521; G06T 7/60; G06T 7/90; G06T 2207/10024; G06T 2207/20212; G06T 2207/30141; G06T 2207/30148

(57) ABSTRACT

The invention relates to an inspection system (26) for analyzing defects in a product, the inspection system (26) comprising a projection device (32), an optical detection device (28) and a processing device, a spectrometer member being configured to split white light into its spectral components and project a multichromatic light beam (37) thus formed from monochromatic light beams onto a product, the detection device having a detection unit (29) comprising an area scan camera (27) and an objective (28), the area scan camera being configured to detect the light beam (37) reflected on the product in a detection plane (46) of the detection unit, the detection plane (46) being perpendicular, preferably orthogonal, to a product surface (38) of the product. The detection unit has a dispersive or diffractive element (31) disposed in the detection plane in the objective or between the objective and the product, the reflected light beam being projectable onto an image plane (49) of the area scan camera, the processing device being configured to derive a height information of the product surface.

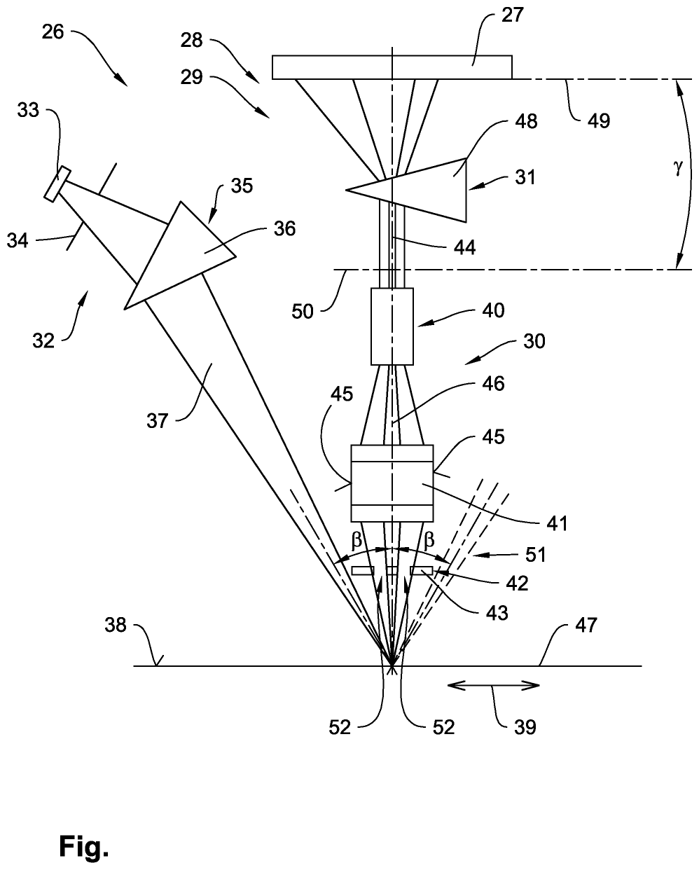

The invention relates to an inspection system and to a method for analyzing defects in a product, in particular a printed circuit board product, a semiconductor wafer or the like, the inspection system comprising a projection device, an optical detection device and a processing device, the projection device having at least one spectrometer member configured to split white light into its spectral components and project a multichromatic light beam thus formed from monochromatic light beams onto a product at an angle of incidence β, the optical detection device having a detection unit comprising an area scan camera and an objective, the area scan camera being configured to detect the multi-chromatic light beam reflected on the product in a detection plane of the detection unit, the detection plane being perpendicular, preferably orthogonal, to a product surface of the product.

In the case of known inspection systems or methods for analyzing defects in a product, a height profile, for example of a printed circuit board or of components disposed on a printed circuit board, can be determined by means of a spectroscopic method. The product to be inspected may be what is known as a PCB (printed circuit board) or a photovoltaic cell. PCBs can be formed, for example, by printing a conductive paste onto a printed circuit board substrate to form conductive tracks or electronic components, such as resistors. Various materials, such as copper, gold, aluminum, titanium, etc., can be applied to the substrate. The printed circuit board product may further be fitted with wired components or what is referred to as SMD components, coated with solder resist and soldered as part of the manufacturing process in question, for example by wave soldering. In these manufacturing processes, a number of defects can occur, such as an incompletely printed conductor track, a defective solder joint or a missing component, which can lead to the printed circuit board product being unable to function. It is therefore regularly necessary for the printed circuit board product to be analyzed for possible defects during its manufacture.

Such a defect analysis is regularly carried out using an inspection system that has a camera for capturing images of the printed circuit board product. The camera may be what is referred to as a line scan camera, which has optical sensors disposed in a line or row or three rows or lines each having different sensors (RGB sensors), or an area scan camera having more than three rows or lines. A disadvantage of the known inspection systems is that the inspection system is able to analyze products with sufficient image quality only up to a certain size, as the line or row length of the optical sensors of the known cameras is limited due to the manufacturing process. For defect analysis, it may therefore be necessary to scan a product in several passes in order to capture the entire product surface or its relevant sections.

EP 2 307 852 B1 describes an inspection system and a method for analyzing defects in PCBs that can be used to optically measure a PCB surface. A polychromatic light beam emanating from a white light source is passed through a prism to generate a multichromatic light beam which is projected onto the printed circuit board product at an angle of incidence. Depending on a difference in height of a surface of the printed circuit board product, the surface appears, as a function of its height, in a spectral color of the multichromatic light beam directed at this height. A monochromatic light beam reflected from the surface in question in this manner is detected by means of an optical detection device, in particular a line scan camera, or a line of an area scan camera. By means of a processing device or a device for data processing, height information of the relevant surface of the printed circuit board product can then be calculated by setting the desired angle of incidence for directing the multichromatic light beam at the detection plane and setting the position of the printed circuit board product relative to the line scan camera.

A disadvantage of the inspection system or method described above is that a surface of the PCB cannot always be reliably detected. Depending on the reflectance or the color of the product surface, there may be deviations in a reflection of the relevant light beam on the product surface. For a reliable defect analysis, multiple images of the printed circuit board product or the PCB are therefore regularly required, or the product is illuminated with differently colored light, or the RGB channels that appear most suitable for a defect analysis are processed further using the processing device. To create a height profile and to obtain a good-quality analysis image of the product, however, different illumination devices, each with associated detection units, are regularly required, which can then scan the product surface sequentially or in separate passes. This makes the defect analysis itself and the constructive design of the inspection system complex. Another disadvantage is that the height information obtained for the surface in question may be inaccurate. Depending on the height of the surface, there may be blurring in an image plane of the optical detection device or on the line scan camera or the area scan camera. This makes a height measurement less accurate, and this blurring cannot be compensated for by using a camera chip with a higher resolution.

The object of the present invention is to propose an inspection system and a method for analyzing defects in a product that enable a reliable defect analysis by simple means.

This object is attained by an inspection system having the features of claim 1 and a method having the features of claim 13.

The inspection system according to the invention for analyzing defects in a product, in particular a printed circuit board product, a semiconductor wafer or the like, comprises a projection device, an optical detection device and a processing device, the projection device having at least one spectrometer member configured to split white light into its spectral components and project a multichromatic light beam thus formed from monochromatic light beams onto a product at an angle of incidence β, the optical detection device having a detection unit comprising an area scan camera and an objective, the area scan camera being configured to detect a multichromatic light beam reflected on the product in a detection plane of the detection unit, the detection plane being perpendicular, preferably orthogonal, to a product surface of the product, wherein the detection unit has a aperture on the image side, the aperture forming at least two slits, the aperture being disposed in the detection plane in the objective or between the objective and the product, the reflected multichromatic light beam being projectable onto an image plane of the area scan camera, the processing device being configured to derive a height information of the product surface from a spatial distribution of saturation values of the reflected multichromatic light beam in the image plane, a position of the optical detection unit relative to the product and the angle of incidence β.

Depending on a difference in height of a product surface, a reflection image of the multichromatic light beam on the product surface shifts relative to an optical axis of the objective or to the detection plane of the detection unit or the area scan camera due to the multichromatic light beam directed at the detection plane at the angle of incidence β, the wavelength of the multichromatic light beam varying with a height in the detection plane. As a result, the reflection image in question is projected into the image plane of the area scan camera at an offset relative to the optical axis or the detection plane as a function of the wavelength or the height, as well. By determining a location of the image in the image plane, it is then possible for the processing device to calculate the height information of the product surface.

The aperture can be disposed or aligned in the direction of the longitudinal axis of the area scan camera. The aperture is therefore designed with two slit masks or slits, which are disposed between the product and the objective in the light beam. Optionally, more than two slit masks or slits may also be provided. Alternatively, the aperture may also be disposed inside the objective. Both slits may be positioned symmetrically relative to the detection plane. Using the aperture makes it possible to obtain a more differentiated and sharper split of the light beam projected onto the image plane of the area scan camera. In particular, two areas of the image plane of the area scan camera on which the light beam falls can then be detected. Among other things, a distance between these areas can also be determined in this case. This splitting on a detection path, i.e., in the objective or between the objective and the product, allows multiple areas or positions of the area scan camera to be used for color recognition. In particular when a grayscale chip is used as the area scan camera, a higher resolution and a more precise color determination can be effected compared to an RGB chip. Also, a grayscale chip does not require color filters, meaning a maximum sensitivity of the grayscale chip can be used. Overall, this enables improved resolution of a height measurement and a more precise determination of the height information of the product surface.

Furthermore, line images may be captured in at least two positions in the image plane each with at least two sensor lines of the area scan camera that have above-average saturation values using the processing device. A shift of the reflection image in the image plane is then determined by evaluating a spatial distribution or an apparent width of saturation values using the processing device. The location of the shift is determined from the spatial distribution or the apparent width of the saturation values in the two positions, as the sensor lines of the area scan camera with the above-average saturation values represent the same. It is therefore sufficient to determine no more than two sensor lines with above-average saturation values using the processing device and to capture the line images imaged on these sensor lines in the image plane. This not only makes it possible to determine the height or a topography but also to capture line images of the product surface at the same time.

Height information of the product surface can be derived depending on the position of the spatial distribution of saturation values in the image plane of the area scan camera. Since the aperture splits the light beam passing through the objective, the image plane of the area scan camera can be used in a more differentiated manner. This results in a broad spatial distribution of saturation values in the image plane of the area scan camera. The broad spatial distribution of the light beam in the image plane also makes it possible to obtain even more precise height information of the product surface. In this manner, a wavelength or a wavelength range of the light beam can be analyzed even more precisely via a distribution of the saturation values and more exact color information and thus height information can be obtained.

The detection unit may have a dispersive or diffractive element disposed in the beam path between the objective and the area scan camera. Using the dispersive or diffractive element together with the aperture makes it possible to achieve a further improved image in the image plane. The light beam formed from monochromatic light beams and reflected by the object can be split again by the dispersive or diffractive element. Depending on the wavelength or wavelength range of the light beam, the spatial distribution of saturation values in the image plane or a distance between positions changes, allowing a wavelength or height information to be determined even more precisely.

Also, a further optical element may be disposed in the beam path between the objective and the area scan camera in such a manner that a longitudinal color error is corrected accordingly. The detection unit may therefore have a correction device, the correction device being configured to correct a longitudinal chromatic aberration of the reflected multichromatic light beam in the image plane. The multichromatic light beam, which is formed from monochromatic light beams, can be projected onto the image plane of the detection device or the area scan camera via the dispersive or diffractive element, the light beam representing the height information of an object surface as a function of the wavelength of the monochromatic light beam. In this manner, a length offset of the monochromatic light beam in question can result as a function of the wavelength of the monochromatic light beam, which represents the height information of an object surface: said length offset may lead to blurring in the image plane for this light beam. In this case, the correction device is configured to optically correct this longitudinal chromatic aberration of the multichromatic light beam or the monochromatic components in question for the image plane. This makes it possible to always obtain an essentially sharp image in the image plane and thus clearer and more accurate height information regardless of a height information or a wavelength of the monochromatic light beam projected onto the image plane. A resolution of a height can thus be significantly improved.

The dispersive or diffractive element may be a prism or a diffraction grating. In a particularly simple embodiment, the prism may be a dispersion prism in the form of an isosceles triangle, for example.

By using the dispersive or diffractive element, which is positioned directly in front of the area scan camera or between the area scan camera and the objective, line images in different color gradations can be obtained. Colors reflected particularly well by the product surface are projected onto the area scan camera or the image plane, where they have higher saturation values.

Alternatively, the image plane of the area scan camera may be inclined by an angle γ≠0° relative to a main plane of the objective in such a manner that the image plane is adapted to the longitudinal chromatic aberration of the reflected multichromatic light beam. The correction device can therefore already be formed by the fact that the image plane of the area scan camera is inclined relative to the main plane of the objective. The image plane and the main plane are then no longer disposed parallel to each other. In principle, the image plane is then also inclined relative to an optical axis of the detection device or of the objective. This inclination allows the longitudinal color error that would otherwise occur to be corrected in such a manner that a comparatively sharp image is always formed regardless of the wavelength of the respective monochromatic light beams projected onto the image plane.

The processing device can be used to derive an analysis image of the product from a plurality of line images. The processing device can then combine the captured line images in the course of a scanning process to form an analysis image of the product surface. In particular, height information and a high-quality analysis image can be obtained simultaneously in a single scan of the product surface.

By means of the objective, a line image can be projected from an object plane of the product surface onto an image plane of the area scan camera: the area scan camera may be disposed transversely, preferably orthogonally, to a direction of movement of a product. For example, the area scan camera may have a rectangular sensor surface, allowing a detection width in relation to a product surface to be optimally utilized. In this case, the objective serves to project a line image which corresponds to a multichromatic light beam reflected on the product and which can be captured by the objective into the image plane of the area scan camera. Due to a dispersive element disposed between the objective and the area scan camera, a beam path is divergent and the projection into the image plane is spectrally distributed across the image plane according to the spectrum of the spectrometer member and the multichromatic light beam reflected on the product due to the refraction of the dispersive element.

The area scan camera may be formed by an RGB chip or a grayscale chip which has 32 to 128 sensor lines, preferably 32 to 64 sensor lines, transverse, preferably orthogonal, to a direction of movement of a product. For example, the area scan camera may have 1024 pixels×36 sensor lines, 2048 pixels×72 sensor lines, 4096 pixels×128 sensor lines, 16,384 pixels×256 sensor lines or more. In principle, a higher resolution can be achieved with a grayscale chip, as all sensor lines of the grayscale chip can be used regardless of a wavelength of the light. Nevertheless, it is also possible to use an RGB chip.

The projection device may emit light in the red, green, blue (RGB), infrared (IR) and/or ultraviolet (UV) wavelength ranges, preferably in a wavelength range of 400 to 700 nm, and the area scan camera can detect this light.

The inspection system may have a further projection device, in which case the projection devices may be disposed symmetrically relative to the detection plane. The fact that the projection devices are disposed symmetrically in relation to the detection plane means that shadows caused by light on the product surface can be advantageously avoided. This makes it possible to take essentially shadow-free images of a product.

The further projection device may emit light with a different wavelength range than the projection device or with a matching wavelength range. The further projection device may be configured identically to the projection device. Nevertheless, the further projection device may emit light of a different wavelength range. Thus, it is also possible for the projection device in question to be calculated from the image captured by the area scan camera. This may also result in multiple spaced-apart areas with above-average saturation values in the image plane of the area scan camera. This also makes it possible to generate many different features of the product with one image capture. If the projection device and the further projection device use light in different wavelength ranges, the product can be illuminated with light of a shorter wavelength and with light of a longer wavelength at the same time. What is particularly advantageous here is that the aperture enables a sharp separation of illumination sources or the projection device and the further projection device on the detection plane of the area scan camera. It is then possible to differentiate particularly well between light from the projection device and light from the further projection device. If present, the dispersive or diffractive element can then split this light, which is reflected by the product, again. In this manner, even more precise height information can be determined overall. A total of three or more matching or different projection devices may also be provided. In this manner, a plurality of projection devices can be used to generate multiple images in a single scan. This can significantly speed up the inspection of products. The product can also be inspected simultaneously for a variety of defect types, which may require different lighting for optimum detection.

The further projection device may emit light with a different height in the detection plane than the projection device relative to the object plane. Alternatively, the further projection device and the projection device may be disposed at different heights relative to the product surface in order to illuminate the product surface at a height with different wavelength ranges.

The objective may be a telecentric objective with a aperture on the image side. The beam path of the objective may then run at least partially parallel within the objective. The aperture or aperture aperture on the image side may be disposed in a focal plane of the objective on the objective side. Consequently, the objective may also be a partially telecentric objective.

The objective may have a front lens that is formed by a converging lens and/or by an achromatic lens. The achromatic lens may be composed of at least two lenses, the lenses of the achromatic lens being glued together or merely placed one inside the other, with a very thin air gap being formed. The air gap between the lenses may be up to 100 μm, for example. This makes it possible to form an achromatic lens particularly cost-effectively and to dispense with gluing the lenses together. The use of an achromatic lens makes it possible to correct color errors or distortion errors.

The front lens may be a cylindrical or spherical lens. It may be sufficient to use a cylindrical lens alone as the front lens, as only a light slit in the image plane or the line image needs to be imaged. By using the cylindrical lens, it is possible to save costs in the manufacture of the inspection system.

The front lens may be in the shape of a circle segment with two coaxial and parallel boundary surfaces. If the front lens is a cylindrical lens, the edges of the front lens may be cut off so that a rod-shaped lens which includes a main axis of the cylindrical lens remains. If the front lens is a spherical lens, boundary surfaces at the outer ends of the front lens may also be parallel, in which case the front lens may only approximately correspond to a circle segment. Using a rod-shaped front lens configured in this manner, it is possible to save installation space next to the detection unit compared to a completely circular front lens and then use this installation space for placing the projection device or an illumination device. The inspection system becomes particularly compact in this case.

A circle segment of the front lens may have a depth of <20 mm, preferably 10 mm, and the front lens may have a width of >250 mm, preferably 180 mm. The width of the front lens may also be understood as a diameter of the front lens. The depth of the front lens may correspond to a relative distance between the parallel boundary surfaces.

The optical detection device may have at least one second detection unit with a second area scan camera, a second dispersive or diffractive element and a second objective, and the area scan cameras may be disposed in alignment relative to one another in the direction of their longitudinal axes. The area scan cameras may be disposed in such a manner at a distance relative to one another that the respective line images of the area scan cameras which may be captured from the object plane by the area scan cameras in a common detection plane may partially overlap, the processing device being configured to assemble or combine the overlapping line images into a combination line image, the processing device being configured to derive an analysis image of the product from a plurality of combination line images.

The second detection unit of the optical detection device may be disposed in such a manner with the second area scan camera and the second objective that the area scan cameras are positioned in a row with respect to their longitudinal axes and thus transversely to the direction of movement. The area scan cameras may be disposed at a distance relative to each other but adjacent to each other. The line images in the object plane are comparatively larger than the line images in the image plane of the area scan camera, which makes it possible to arrange the detection units or area scan cameras in such a manner that the respective line images of the area scan cameras partially overlap at their longitudinal ends, i.e., that the area scan cameras can each capture matching sections (b) of the product surface. The processing device may be configured in such a manner that it can assemble or combine these overlapping line images into a combination line image. This makes it possible in principle to form an inspection system with an almost arbitrarily large detection width (E) by forming a row of area scan cameras or detection units. A total width of a product may then be captured in one scan pass, and the combination line images may be combined to form the analysis image of the product using the processing device.

The combination line image may have a detection width (E) in the object plane that is greater than a detectable width (B) of the line image in the object plane. Consequently, the respective line images do not overlap completely but only in an overlapping section (b). For example, the overlapping section may be 1 mm to 3 mm in size.

A detectable width (B) of the line image in the object plane may be greater than a diameter (D) of the objective or a length (L) of the area scan camera. This makes it possible to arrange area scan cameras with aligned longitudinal axes next to each other and still obtain an undivided combination line image in the first place. The diameter of the objective is understood to be a maximum external dimension of the objective, and the length of the area scan camera is understood to be a maximum external length of the area scan camera.

An optical axis of the objective may be disposed orthogonally relative to the object plane and transversally to the direction of movement, and a convergent beam path of the objective may run at an angle α>80° and <90° relative to the object plane. The convergent beam path of the objective makes it possible to partially overlap the line images of the object plane and at the same time to arrange the detection units next to each other, possibly with a space in between. The optical axes of the respective objectives may then be disposed in parallel in the detection plane.

It is particularly advantageous if the line images overlap by 1 mm to 3 mm. In this case, the processing device may be configured to combine the line images to form the combination line image based on matching pixels in the overlapping areas. By adding the line images in the overlap area, it is possible to achieve a particularly good image quality in the overlap area. The objective may then also have imaging errors in the edge area of its detectable width, which may then be tolerated.

The projection device may have an illumination device, and the illumination device may be configured to project diffuse light onto the product, and the area scan camera may be configured to detect light of the diffuse light reflected on the product in the detection plane. The illumination device may have a diffuser, by means of which a homogeneous distribution of the light on the product surface may be achieved while avoiding strong contrasts. The illumination device may emit light in the red, green and blue (RGB), infrared (IR) and/or ultraviolet (UV) wavelength ranges. Also, color components of the light may be selectable as desired in order to mix certain wavelength ranges. The illumination device may be composed of a number of light-emitting diodes (LEDs) disposed in rows or a matrix. Also, the illumination device may have a polarization filter.

The projection device may have a second illumination device, and the first and second illumination devices may be disposed coaxially relative to the optical detection device. The illumination devices may also be disposed transversely or orthogonally to the direction of movement of the product. This avoids a possible formation of shadows on the product surface. The structure of the second illumination device may correspond to that of the first illumination device.

In the method according to the invention for analyzing defects in a product, in particular a printed circuit board product, a semiconductor wafer or the like, using an inspection system comprising a projection device, an optical detection device and a processing device, a spectrometer member of the projection device splits white light into its spectral components by means of and projects a multichromatic light beam thus formed from monochromatic light beams onto a product at an angle of incidence β, the optical detection device having a detection unit comprising an area scan camera and an objective, a multichromatic light beam being reflected on the product in a detection plane of the detection unit, the detection plane being perpendicular, preferably orthogonal, to a product surface of the product, the area scan camera detecting said multichromatic light beam, wherein a aperture on the image side projects the reflected multichromatic light beam onto an image plane of the area scan camera, the aperture forming at least two slits, the aperture being disposed in the detection plane in the objective or between the objective and the product, the processing device deriving a height information of the product surface from a spatial distribution of saturation values of the reflected multi-chromatic light beam in the image plane, a position of the optical detection unit relative to the product and the angle of incidence β. With regard to the advantageous effects of the method according to the invention, reference is made to the description of ad-vantages of the inspection system according to the invention.

By means of the processing device, at least three, preferably five, sensor lines of the area scan camera with the highest saturation values may simultaneously capture line images. For example, it is then also possible to superimpose at least two of the sensor lines or their line images in order to obtain a single quality-optimized line image. At the same time, an amount of data to be processed will also be small, which enables fast processing of the image data and therefore a fast scan of the product. By superimposing the line images, it will be possible to capture only one line image of the reflected multichromatic light beam with the area scan camera. The area scan camera is therefore used simultaneously for determining the topography and for selecting usable line images.

A further projection device of the inspection system is configured to emit light with a different wavelength range than the projection device or a matching wavelength range, the area scan camera being configured to simultaneously capture line images of the projection device and the further projection device. The processing device may also be used to analyze the image information or RGB color information separately according to hue (H), saturation(S) and value (V) in a color space (HSV, HSL, HSB).

The processing device is configured to derive further height information of the product surface from a spatial distribution of saturation values of the reflected multichromatic light beam of the further projection device in the image plane, a position of the optical detection unit relative to the product and the angle of incidence β. The wider spatial distribution of the light beam in the image plane makes it possible to obtain even more precise height information of the product surface. In this manner, a wavelength or wavelength range of the light beam can be analyzed even more precisely based on the distribution of the saturation values and more accurate color information and thus height information can be obtained.

The image plane or an image in the image plane of the area scan camera may therefore be analyzed in terms of hue, brightness and/or saturation using the processing device. The image information may be used in particular to analyze the material type and the distribution, as different materials have different H, S and V values. A color space may be selected as a function of the materials to be analyzed: an RGB color space may serve as the basis.

The processing device may be used to determine a material, a material property and/or a geometric structure of the product from the analysis image and/or to compare the analysis image with a reference image. Further material structure information of a product may be obtained if line images of the analysis image are superimposed and evaluated using the processing device. For example, two line images of a matching product surface may be combined using the image processing of the processing device. Optionally, sequential illumination by means of the spectrometer member may also take place. In this case, a first analysis image is first recorded with illumination in a single wavelength range, and then a second analysis image is captured with illumination in a single different wavelength range of a matching product surface. Finally, the analysis images are combined using image processing. The processing device may further be used to compare analysis image information or analysis images with reference images as part of a defect analysis. The reference images of the product may include CAD data and material distribution data of the product. The comparison may be carried out by image processing, wherein difference images may be analyzed separately for different structures of the product. Furthermore, this material information may be combined with height information in order to clearly identify a conductor track, for example. The reference image information may therefore include all geometric data of the product, material information, component information and also height information. If the analysis image information deviates from the reference image information, a defect may be signaled.

In this way, at least two or more line images of a matching product surface can be combined using the image processing of the processing device. This may result in what is referred to as an HDR (high dynamic range) image. A graduated series of exposures may be achieved by adjusting the illumination using the spectrometer member and/or a correspondingly different detection of the sensor lines of the area scan camera using the processing device. For example, a 12-bit analysis image of the area scan camera in which several brightnesses are integrated in 8-bit format may be read out by means of the processing device. Overall, a color location of a color space of a pixel of the analysis image in question may thus be determined even more precisely.

Further advantageous embodiments of the method are apparent from the descriptions of features of the claims dependent on the device claim.

Hereinafter, a preferred embodiment of the invention is explained in more detail with reference to the attached Figure. The Figure shows a simplified principle representation of an embodiment of an inspection system 26 in a side view. The inspection system 26 has an area scan camera 27. Furthermore, a detection device 28 having a detection unit 29 comprising the area scan camera 27, an objective 30 and a dispersive element 31 is shown together with a projection device 32. The projection device 32 has a light source 33, which emits white light, a aperture 34 and a further dispersive element 35. The further dispersive element 35 is formed by a further prism 36, by means of which a multichromatic light beam 37 is projected onto a product surface 38 of a product (not shown) transversely to a direction of movement indicated by an arrow 39.

The objective 30 comprises a lens assembly 40, which is shown schematically here, a front lens 41 and a aperture 42 disposed on the image side. The aperture 42 is configured in particular as a slit aperture 43. The front lens 41 is in the shape of a circle segment and has two parallel boundary surfaces 45 coaxial with an optical axis 44. The optical axis 44 runs through a detection plane 46 of the detection unit 29, the detection plane 46 being orthogonal to the product surface 38, which corresponds to an object plane 47. The multichromatic light beam 37 strikes the product surface 38 or the object plane 47 at an angle β relative to the detection plane 46 and is reflected from there into the objective 30. The dispersive element 31, which is formed by a prism 48, is disposed between the objective 30 and the area scan camera 27. The prism 48 disperses the light emerging from the objective 30 and projects it onto the area scan camera 27 or its image plane 49. Furthermore, a correction device (not shown) is provided in this case, the correction device correcting a longitudinal chromatic aberration of the reflected multichromatic light beam in the image plane 49. The correction device may be formed by the mere fact that the image plane 49 is pivoted, i.e., not parallel, relative to a main plane 50 of the objective 30. So an angle γ≠0 is formed between the image plane 49 and the main plane 50. The inclination of the image plane 49 is selected in such a manner that, regardless of the wavelength of the light dispersed by the prism 48, said light is imaged with sufficient sharpness in the image plane 49. Alternatively or additionally, a further optical element (not shown) which corrects the longitudinal chromatic aberration accordingly may be disposed on the optical axis 44 between the objective 30 and the image plane 49.

A processing device (not shown) derives height information of the product surface 38 relative to the area scan camera 27 based on a spatial distribution of the reflected multichromatic light beam 37 on the area scan camera 27. For this purpose, sensor lines (not shown) of the area scan camera 27 which run parallel to the detection plane 46 are evaluated, five sensor lines with the highest or maximum saturation values being detected. The height information may then be calculated from a position of the sensor lines relative to the detection plane 46 and the angle of incidence β. This height information is always consistently accurate regardless of the height of the product surface 38, as the accuracy is independent of a wavelength of the light projected onto the detection plane 46 due to the use of the correction device. Furthermore, the processing device is used to superimpose the sensor lines or their line images. These line images are in turn combined to form an analysis image of the product.

Furthermore, a further projection device 51 of the inspection system 26, shown here by way of indication, may be provided. The further projection device 51 is identical in structure to the projection device 32 and is disposed symmetrically to the projection device 32 relative to the detection plane 46. In particular, the further projection device 51 is also positioned at the angle of incidence β relative to the detection plane 46. The further projection device 51 emits light with a wavelength range that differs from that of the projection device 32 onto the product surface 38. The area scan camera 27 can then simultaneously capture line images in the respective wavelength ranges of the projection device 32 and the further projection device 51. In this manner, at least two three-dimensional images of the product surface 38 can be generated with a single image acquisition. Since both three-dimensional images are based on light with different wavelength ranges, further features of the product surface 38 and even more precise height information can be obtained.

The slit aperture 43 has two slits 52, which are aligned in the direction of a longitudinal axis or the detection plane 46 of the area scan camera 27. The slits 32 are disposed symmetrically relative to the detection plane 46. The light reflected by the product surface 38 passes through the slits 52 and the objective 30 onto the image plane 49 of the area scan camera 27, the dispersive element 31 deflecting the light depending on its wavelength. The two slits 52 also make it possible to achieve a sharp split between light from the projection device 32 and the further projection device 51. Differentiation is particularly easy here, as the slit aperture 43 causes a different pattern to appear on the image plane 49 depending on the reflecting wavelength on the product surface 38 as a function of the projection device 32 or the further projection device 51.

1. An inspection system (26) for analyzing defects in a product,
in particular a printed circuit board product, a semiconductor wafer or the like, the inspection system comprising a projection device (32), an optical detection device (28) and a processing device, the projection device having at least one spectrometer member configured to split white light into its spectral components and project a multichromatic light beam (37) thus formed from monochromatic light beams onto a product at an angle of incidence β, the optical detection device having a detection unit (29) comprising an area scan camera (27) and an objective (30), the area scan camera being configured to detect the multichromatic light beam (37) reflected on the product in a detection plane (46) of the detection unit, the detection plane (46) being perpendicular to a product surface (38) of the product,
wherein the detection unit has a aperture (42) on the image side, the aperture forming at least two slits (52), the aperture being disposed in the detection plane in the objective or between the objective and the product, the reflected multichromatic light beam being projectable onto an image plane (49) of the area scan camera, the processing device being configured to derive a height information of the product surface from a spatial distribution of saturation values of the reflected multichromatic light beam in the image plane, a position of the optical detection unit relative to the product and the angle of incidence β.

2. The inspection system according to claim 1, wherein the processing device is configured to capture line images in at least two positions in the image plane (49), each with at least two sensor lines of the area scan camera (27) that have above-average saturation values.

3. The inspection system according to claim 1, wherein height information of the product surface is derivable depending on a position of the spatial distribution of saturation values in the image plane (49) of the area scan camera (27).

4. The inspection system according to claim 1, wherein the detection unit (29) has a dispersive or diffractive element (31) disposed in the beam path between the objective (30) and the area scan camera (27).

5. The inspection system according to claim 1, wherein the processing device is configured to derive an analysis image of the product from a plurality of line images.

6. The inspection system according to claim 1, wherein the objective (30) is configured to project a line image from an object plane (47) of the product surface (38) onto the image plane (49) of the area scan camera (27), the area scan camera being disposed perpendicularly to a direction of movement (39) of a product.

7. The inspection system according to claim 1, wherein the area scan camera (27) is formed by a RGB chip or a grayscale chip having 32 to 128 sensor lines perpendicular to a direction of movement (39) of a product.

8. The inspection system according to claim 1, wherein the processing device is configured to derive an analysis image of the product from a plurality of line images.

9. The inspection system according to claim 1, wherein the objective (30) is configured to project a line image from an object plane (47) of the product surface (38) onto the image plane (49) of the area scan camera (27), the area scan camera being disposed perpendicularly to a direction of movement (39) of a product.

10. The inspection system according to claim 7, wherein the area scan camera (27) is formed by a RGB chip or a grayscale chip having 32 to 64 sensor lines, perpendicular to a direction of movement (39) of a product.

11. The inspection system according to claim 9, wherein the further projection device (51) emits light with a different height in the detection plane (46) than the projection device (32) relative to the object plane (47).

12. The inspection system according to claim 1, wherein the objective (30) is a telecentric objective.

13. A method for analyzing defects in a product, in particular a printed circuit board product, a semiconductor wafer or the like, the method using an inspection system (26), the inspection system comprising a projection device (32), an optical detection device (28) and a processing device, a spectrometer member of the projection device splitting white light into its spectral components and projecting a multichromatic light beam (37) thus formed from monochromatic light beams onto a product at an angle of incidence β, the optical detection device having a detection unit (29) comprising an area scan camera (27) and an objective (30), a multichromatic light beam (37) being reflected on the product in a detection plane (46) of the detection unit, the detection plane being perpendicular, preferably orthogonal, to a product surface of the product, the area scan camera detecting said multichromatic light beam,
wherein an aperture (42) of the detection unit on the image side projects the reflected multichromatic light beam onto an image plane (49) of the area scan camera, the aperture forming at least two slits (52), the aperture being disposed in the detection plane in the objective or between the objective and the product, the processing device deriving a height information of the product surface from a spatial distribution of saturation values of the reflected multichromatic light beam in the image plane, a position of the optical detection unit relative to the product and the angle of incidence β.

14. The method according to claim 13, wherein the processing device simultaneously detects line images from at least three sensor lines of the area scan camera (27) that have the highest saturation values.

15. The method according to claim 13, wherein a further projection device (51) of the inspection system (26) emits light, the area scan camera (27) simultaneously capturing line images of the projection device and the further projection device.

16. The method according to claim 15, wherein the processing device derives further height information of the product surface from a spatial distribution of saturation values of the reflected multichromatic light beam (37) of the further projection device (51) in the image plane (49), a position of the optical detection unit (29) relative to the product and the angle of incidence β.

17. The method according to claim 13, wherein the processing device analyses the image plane (49) of the area scan camera (27) for at least one of hue, brightness and saturation.

18. The method according to claim 13, wherein the processing device determines at least one of a material, a material property and a geometric structure of the product from the analysis image and/or compares the analysis image to a reference image.

19. The method according to claim 13, wherein the processing device combines at least two or more line images of a matching product surface (38) by image processing.
